(19) United States
(12) Patent Application Publication
(10) Pub. No.: US 2025/0139702 A1
(43) Pub. Date: May 1, 2025

(54) SYSTEM AND METHOD FOR OPTIMIZED ASSET ALLOCATION RECOMMENDATIONS BASED ON SOCIO-ECONOMIC TRENDS

(71) Applicant: JPMorgan Chase Bank, N.A., New York, NY (US)

(72) Inventors: Abhinandan CHAUDHURY, Bengaluru (IN); Prashanth IYER, Bangalore (IN)

(73) Assignee: JPMorgan Chase Bank, N.A., New York, NY (US)

(21) Appl. No.: 18/397,621

(22) Filed: Dec. 27, 2023

(30) Foreign Application Priority Data
Oct. 26, 2023 (IN) 202311072967

(51) Int. Cl. G06Q 40/06

(52) U.S. Cl. CPC G06Q 40/06

(57) ABSTRACT

A system and method for optimized asset allocation recommendations based on socio-economic trends are disclosed. The method includes receiving first information associated with a set of assets, and a set of beneficiary entities associated with a user. Further, the method includes retrieving second information associated with the set of assets and a testament from at least one external resource. Further, the method includes analyzing, using a recommendation engine, the first information and the second information to determine an optimized allocation of the set of assets to the set of beneficiary entities. Further, the method includes generating a preliminary testament draft based on the optimized asset allocation recommendation. Further, the method includes rendering, via a display, the generated preliminary testament draft to the user to prompt the user to provide a user input. Thereafter, the method includes generating a final testament draft based on the user input.

### CROSS-REFERENCE TO RELATED APPLICATIONS

This application claims priority benefit from Indian Application No. 202311072967, filed on Oct. 26, 2023 in the India Patent Office, which is hereby incorporated by reference in its entirety.

### BACKGROUND

### Field of the Disclosure

This technology generally relates to estate planning and decision-making processes. Moreover, the present disclosure relates to optimizing asset allocation recommendations based on socio-economic trends, thereby minimizing biases in allocating assets to beneficiaries.

### Related Art

The following description of the related art is intended to provide background information pertaining to the field of the present disclosure. This section may include certain aspects of the art that may be related to various features of the present disclosure. However, it should be appreciated that this section is used only to enhance the understanding of the reader with respect to the present disclosure, and not as admission of the prior art.

As is generally known, in a conventional manner, preparing a will and testament requires a lot of manual procedure and paperwork. During this cumbersome manual procedure, a person faces different challenges, such as decision-making, asset identification, and the percentage of asset allocation among one or more person's beneficiaries. The decisions on these allocations may be made at the person's discretion without any guidance from anyone based solely on perception and the mental state of the person at that will preparation time. In another way, a person may seek advice from trusted individual people or firms to guide in this decision-making process. The major and important decisions in this process involve, but are not limited to, which beneficiaries should be included in the allocation process, the proportion of assets to be allocated to them, and the type of assets to be allocated to each dependent.

The major drawbacks in the conventional process are that the conventional methods of preparing one's final will and testament are largely based on personal feelings, perceptions, and biases. Factors such as emotional closeness to a particular dependent, likeability factors, or the individual's mood at the time of decision-making can greatly influence asset allocations. This makes the decision-making process highly subjective and potentially prone to inequities or imbalances. The conventional process does not factor in real-time market dynamics, economic indicators, or other important factors that could influence the valuation of assets or the needs of beneficiaries. Once a will is drafted conventionally, it tends to remain static and may not account for changing realities, be it in terms of asset valuations or the changing needs of beneficiaries. Relying solely on personal judgment, especially under time pressure or emotional duress, can lead to errors or oversights that may not serve the best interests of all involved. While individuals can seek advice from trusted entities or professionals, the guidance they receive might still be limited by the adviser's knowledge, biases, or the information available at that point in time. The traditional process does not easily allow for adjustments based on new information, changes in asset value, or shifts in the economic environment. Further, there is no ongoing mechanism to review or suggest adjustments to the will based on new data or changing circumstances.

Hence, in view of these and other existing limitations, there arises an imperative need to provide an efficient solution to overcome the above-mentioned limitations and to provide a method and system that would not only streamline the estate planning process but also make it more accessible, accurate, and adaptive to real-time changes in economic and legal landscapes.

### SUMMARY

The present disclosure, through one or more of its various aspects, embodiments, and/or specific features or sub-components, provides, inter alia, various systems, servers, devices, methods, media, programs, and platforms for optimized asset allocation recommendations based on socio-economic trends.

According to an aspect of the present disclosure, a method for providing optimized asset allocation recommendations is disclosed. The method is implemented by at least one processor. The method includes receiving, by the at least one processor, first information associated with a set of assets and a set of beneficiary entities associated with a user. Next, the method includes retrieving, by the at least one processor, second information associated with the set of assets, the set of beneficiary entities, and a testament from at least one external resource. Next, the method includes analyzing, by the at least one processor using a recommendation engine, the first information and the second information to determine an optimized allocation recommendation of the set of assets to the set of beneficiary entities. Next, the method includes generating, by the at least one processor, a preliminary testament draft based on the optimized asset allocation recommendation. Next, the method includes rendering, by the at least one processor via a display, the generated preliminary testament draft to the user to prompt the user to provide a user input. Thereafter, the method includes generating, by the at least one processor, a final testament draft based on the user input.

In accordance with an exemplary embodiment, the generating of the final testament draft comprises modifying, by the at least one processor, the preliminary testament draft based on the user input; and receiving, by the at least one processor from a pre-authorized legal entity, an input that relates to the modified preliminary testament draft, wherein the generating of the final testament draft is further based on the received input from the pre-authorized legal entity.

In accordance with an exemplary embodiment, the generating of the final testament draft comprises analyzing, by the at least one processor, the user input to determine that the user has approved the preliminary testament draft; and receiving, by the at least one processor from a pre-authorized legal entity, an input that relates to the approved preliminary testament draft, wherein the generating of the final testament draft is further based on the received input from the pre-authorized legal entity.

In accordance with an exemplary embodiment, the method further comprises displaying, by the at least one processor via the display, the generated final testament draft.

In accordance with an exemplary embodiment, the second information comprises a real-time economic indicator, a historical market data, and an existing legal framework that is relevant to estate planning.

In accordance with an exemplary embodiment, the method further includes periodically reviewing, by the at least one processor, a change in at least one from among the economic indicator, the historical market data, and the existing legal framework that is relevant to estate planning after a predefined time period; generating, by the at least one processor, a set of modifications in the optimized asset allocation recommendation based on the change in the at least one from among the economic indicator, the historical market data, and the existing legal framework that is relevant to estate planning; recommending, by the at least one processor, the generated set of modifications to the user; and generating, by the at least one processor, an alert to the user based on the recommendation of the generated set of modifications.

In accordance with an exemplary embodiment, the method further includes updating, by the at least one processor, the recommendation engine based on the user input.

In accordance with an exemplary embodiment, the set of assets comprises at least one from among a real estate asset, a hard commodities investment, a soft commodities investment, a stocks investment, a liquid asset, and an intellectual property investment.

In accordance with an exemplary embodiment, the at least one external resource corresponds to at least one from among economic and market indicators, news and current affairs, and socio-economic and geo-political realities that affect a valuation of the set of assets.

According to another aspect of the present disclosure, a computing device configured to implement an execution of a method for providing an optimized asset allocation recommendation is disclosed. The computing device includes a processor; a memory; and a communication interface coupled to each of the processor and the memory. The processor may be configured to receive first information associated with a set of assets, and a set of beneficiary entities associated with a user. Next, the processor may be configured to retrieve second information associated with the set of assets, the set of beneficiary entities, and a testament from at least one external resource. Next, the processor may be configured to analyze, using a recommendation engine, the first information and the second information to determine an optimized allocation recommendation of the set of assets to the set of beneficiary entities. Next, the processor may be configured to generate a preliminary testament draft based on the optimized asset allocation recommendation. Next, the processor may be configured to render, via a display, the generated preliminary testament draft to the user to prompt the user to provide a user input. Thereafter, the processor may be configured to generate a final testament draft based on the user input.

In accordance with an exemplary embodiment, to generate the final testament draft, the processor is further configured to modify the preliminary testament draft based on the user input; and receive, from a pre-authorized legal entity, an input that relates to the modified preliminary testament draft, wherein the generation of the final testament draft is further based on the received input from the pre-authorized legal entity.

In accordance with an exemplary embodiment, to generate the final testament draft, the processor is further configured to analyze the user input to determine that the user has approved the rendered preliminary testament draft; and receive, from a pre-authorized legal entity, an input that relates to the approved preliminary testament draft, wherein the generation of the final testament draft is further based on the received input from the pre-authorized legal entity.

In accordance with an exemplary embodiment, the processor is further configured to display, via the display, the generated final testament draft.

In accordance with an exemplary embodiment, the second information comprises a real-time economic indicator, a historical market data, and an existing legal framework that is relevant to estate planning.

In accordance with an exemplary embodiment, the processor is further configured to periodically review a change in at least one from among the economic indicator, the historical market data, and the existing legal framework that is relevant to estate planning after a predefined time period; generate a set of modifications in the optimized asset allocation recommendation based on the change in the at least one from among the economic indicator, the historical market data, and the existing legal framework that is relevant to estate planning; recommend the generated set of modifications to the user; and generate an alert to the user based on the recommendation of the generated set of modifications.

In accordance with an exemplary embodiment, the processor is further configured to update the recommendation engine based on the user input.

In accordance with an exemplary embodiment, the set of assets comprises at least one from among a real estate asset, a hard commodities investment, a soft commodities investment, a stocks investment, a liquid asset, and an intellectual property investment.

In accordance with an exemplary embodiment, the at least one external resource corresponds to at least one from among economic and market indicators, news and current affairs, and socio-economic and geo-political realities that affect a valuation of the set of assets.

According to yet another aspect of the present disclosure, a non-transitory computer-readable storage medium storing instructions for providing an optimized asset allocation recommendation is disclosed. The instructions include executable code, which, when executed by a processor, may cause the processor to receive first information associated with a set of assets, and a set of beneficiary entities associated with a user; retrieve second information associated with the set of assets, the set of beneficiary entities, and a testament from at least one external resource; analyze, using a recommendation engine, the first information and the second information to determine an optimized allocation recommendation of the set of assets to the set of beneficiary entities; generate a preliminary testament draft based on the optimized asset allocation recommendation; render, via a display, the generated preliminary testament draft to the user to prompt the user to provide a user input; and generate a final testament draft based on the user input.

In accordance with an exemplary embodiment, to generate the final testament draft, the executable code, when executed, causes the processor to modify the preliminary testament draft based on the user input; and receive, from a pre-authorized legal entity, an input that relates to the modified preliminary testament draft, wherein the generation of the final testament draft is further based on the received input from the pre-authorized legal entity.

In accordance with an exemplary embodiment, to generate the final testament draft, the executable code, when executed, causes the processor to analyze the user input to determine that the user has approved the rendered preliminary testament draft; and receive, from a pre-authorized legal entity, an input that relates to the approved preliminary testament draft, wherein the generation of the final testament draft is further based on the received input from the pre-authorized legal entity.

In accordance with an exemplary embodiment, the executable code, when executed, causes the processor to display, via the display, the generated final testament draft.

In accordance with an exemplary embodiment, the second information comprises a real-time economic indicator, a historical market data, and an existing legal framework that is relevant to estate planning.

In accordance with an exemplary embodiment, the executable code, when executed, causes the processor to periodically review a change in at least one from among the economic indicator, the historical market data, and the existing legal framework that is relevant to estate planning after a predefined time period; generate a set of modifications in the optimized asset allocation recommendation based on the change in the at least one from among the economic indicator, the historical market data, and the existing legal framework that is relevant to estate planning; recommend the generated set of modifications to the user; and generate an alert to the user based on the recommendation of the generated set of modifications.

In accordance with an exemplary embodiment, the executable code, when executed, causes the processor to update the recommendation engine based on the user input.

In accordance with an exemplary embodiment, the set of assets comprises at least one from among a real estate asset, a hard commodities investment, a soft commodities investment, a stocks investment, a liquid asset, and an intellectual property investment.

In accordance with an exemplary embodiment, the at least one external resource corresponds to at least one from among economic and market indicators, news and current affairs, and socio-economic and geo-political realities that affect a valutation of the set of assets.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for optimized asset allocation recommendations based on socio-economic trends, in accordance with an exemplary embodiment.

FIG. 2 illustrates an exemplary diagram of a network environment for optimized asset allocation recommendations based on socio-economic trends, in accordance with an exemplary embodiment.

FIG. 3 illustrates an exemplary system for optimized asset allocation recommendations based on socio-economic trends, in accordance with an exemplary embodiment.

FIG. 4 illustrates an exemplary method flow diagram for optimized asset allocation recommendations based on socio-economic trends, in accordance with an exemplary embodiment.

FIG. 5 illustrates a process flow diagram usable for optimized asset allocation recommendations based on socio-economic trends, in accordance with an exemplary embodiment.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the problems associated with optimized asset allocation recommendations based on socio-economic trends, the present disclosure provides a method and system for optimized asset allocation recommendations based on socio-economic trends. The system facilitates in testament generating and estate planning that is more comprehensive, adaptable, and user-friendly. The system first receives initial information related to a user's set of assets and their beneficiary entities. This sets the stage for all subsequent activities, providing the fundamental data on which asset allocation and testament generation are based. The system retrieves additional data from external resources. This may include various economic and market indicators, such as Gross Domestic Product (GDP), inflation rates, and news updates, among others. This additional layer of information enables a more holistic approach to asset management and testament drafting. The system uses a recommendation engine that corresponds to a trained analytical model to assess both the initial and additional information. Based on this analysis, it determines one or more recommendations for an optimized allocation of assets to the beneficiary entities. The recommendation engine leverages machine learning algorithms for a nuanced analysis, which can be updated and improved over time. The system generates a preliminary testament draft based on the optimized asset allocation recommendations, offering the user a tangible, initial version of their estate planning document. The preliminary testament draft is rendered to the user via a display unit (also referred to herein as a “display”). The user has the opportunity to review and provide feedback, allowing for a more personalized final document. The system can also receive input from pre-authorized legal entities, ensuring that the final testament draft is legally compliant and professionally vetted. Based on both the user's and the legal entity's inputs, the system generates the final testament draft, which is then displayed to the user.

The system periodically reviews changes in economic indicators, market data, and legal frameworks, and can recommend updates to the user. Additionally, alerts can be generated based on these modifications. The recommendation engine used for analysis can be updated based on the received user input, leading to continuous improvement in asset allocation strategies and testament generation over time. The generated final testament draft is displayed to the user for a final review, offering a chance for any last-minute adjustments. The system offers a robust solution for automated, yet personalized, asset allocation and testament generation, overcoming many limitations found in existing methods.

Therefore, the present disclosure aids in generating optimized asset allocation recommendations based on socio-economic trends. The present disclosure provides solutions that use both a first set of information related to the assets and beneficiary entities, as well as a second set of information from external sources, allowing for a more holistic asset allocation strategy. The present disclosure provides solutions that involve periodically reviewing changes in economic indicators, historical market data, and existing legal frameworks, allowing for more dynamic and responsive asset allocation. The present disclosure provides a solution that, by rendering preliminary and final testament drafts to the user, provides a more interactive and user-friendly approach to estate planning.

The ability to receive input from a pre-authorized legal entity ensures that the final testament draft is not only optimized but also legally compliant. The solutions of the present disclosure incorporate real-time economic and market indicators, which are crucial for optimizing asset allocation, especially in volatile markets. The solution of the present disclosure allows for the incorporation of insights from pre-authorized legal entities, thereby elevating the quality and compliance of the final testament draft. The solutions of the present disclosure provide a system that can generate alerts based on the set of modifications, ensuring that the user is promptly informed about crucial changes that could affect their asset allocation and testament. The solutions of the present disclosure provide a system that is designed to handle various types of assets, including real estate, hard and soft commodities, stocks, liquid assets, and intellectual properties. Furthermore, the solution of the present disclosure allows for iterations by receiving user input based on the preliminary testament draft, thus ensuring that the final testament draft more closely aligns with the user's wishes and circumstances.

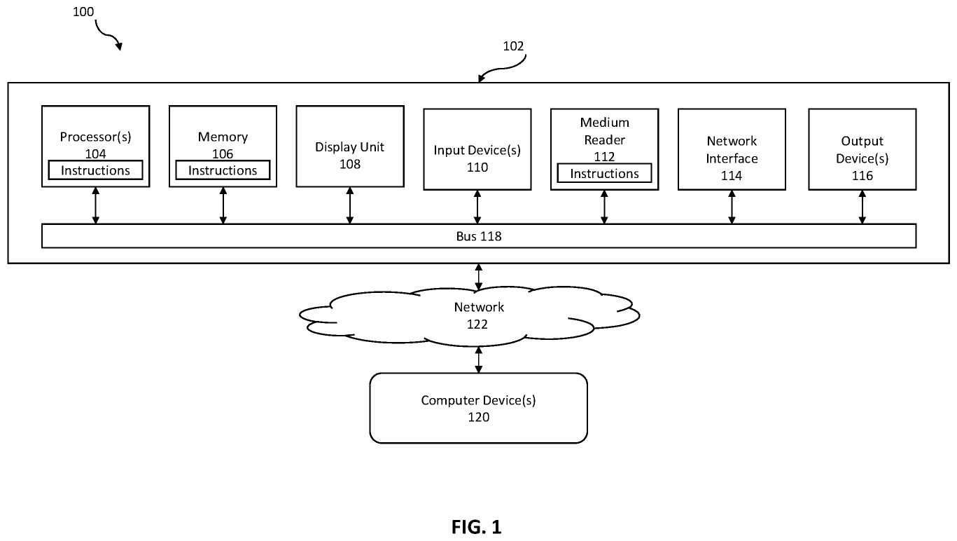

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. Processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “network interface” may also be referred to as “communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing optimized asset allocation recommendations based on socio-economic trends.

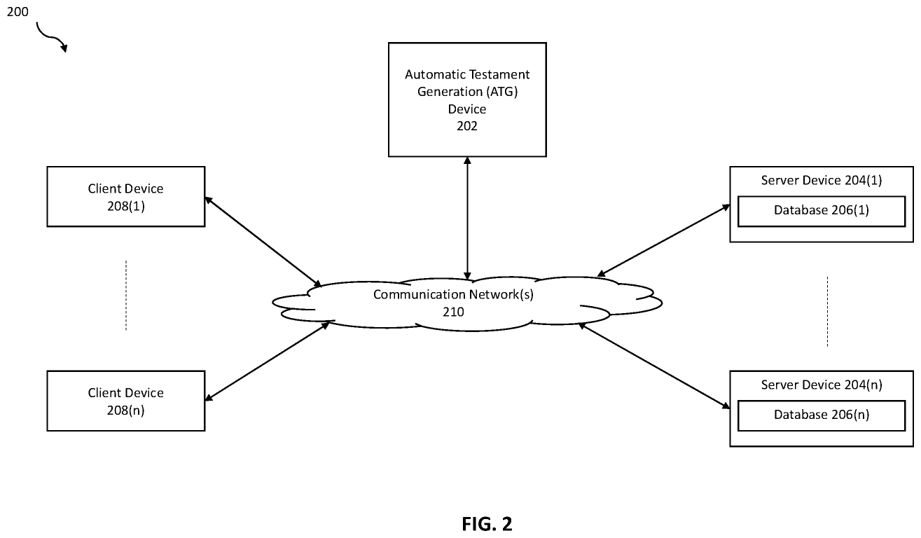

Referring to FIG. 2, a schematic of an exemplary network environment 200 for implementing a method for providing optimized asset allocation recommendations based on socio-economic trends is illustrated. In an exemplary embodiment, the method is executable on any networked computer platform, such as, for example, a personal computer (PC).

The method for providing optimized asset allocation recommendations based on socio-economic trends may be implemented by an Automatic Testament Generation (ATG) device 202. The ATG device 202 may be the same or similar to the computer system 102 as described with respect to FIG. 1. The ATG device 202 may store one or more applications that can include executable instructions that, when executed by the ATG device 202, cause the ATG device 202 to perform desired actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the ATG device 202 itself, may be located in the virtual server(s) running in a cloud-based computing environment rather than being tied to one or more specific physical network computing devices. Also, the application(s) may be running in one or more virtual machines (VMs) executing on the ATG device 202. Additionally, in one or more embodiments of this technology, virtual machine(s) running on the ATG device 202 may be managed or supervised by a hypervisor.

In the network environment 200 of FIG. 2, the ATG device 202 is coupled to a plurality of server devices 204(1)-204(n) that hosts a plurality of databases 206(1)-206(n), and also to a plurality of client devices 208(1)-208(n) via communication network(s) 210. A communication interface of the ATG device 202, such as the network interface 114 of the computer system 102 of FIG. 1, operatively couples and communicates between the ATG device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ATG device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and ATG devices that efficiently implement the method for providing optimized asset allocation recommendations based on socio-economic trends.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Networks (PSTNs), Ethernet-based Packet Data Networks (PDNs), combinations thereof, and the like.

The ATG device 202 may be a standalone device or integrated with one or more other devices or apparatuses, such as one or more of the server devices 204(1)-204(n), for example. In one particular example, the ATG device 202 may include or be hosted by one of the server devices 204(1)-204(n), and other arrangements are also possible. Moreover, one or more of the devices of the ATG device 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the ATG device 202 via the communication network(s) 210 according to the Hypertext Transfer Protocol (HTTP)-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to a preliminary testament draft, a final testament draft, and recommendations provided by the machine learning models and the training data for the machine learning models.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ATG device 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the ATG device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ATG device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ATG device 202, the server devices 204(1)-204(n), or the client devices 208(1)-208(n), for example, may be configured to operate as virtual instances on the same physical machine. In other words, one or more of the ATG device 202, the server devices 204(1)-204(n), or the client devices 208(1)-208(n) may operate on the same physical device rather than as separate devices communicating through communication network(s) 210. Additionally, there may be more or fewer ATG devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

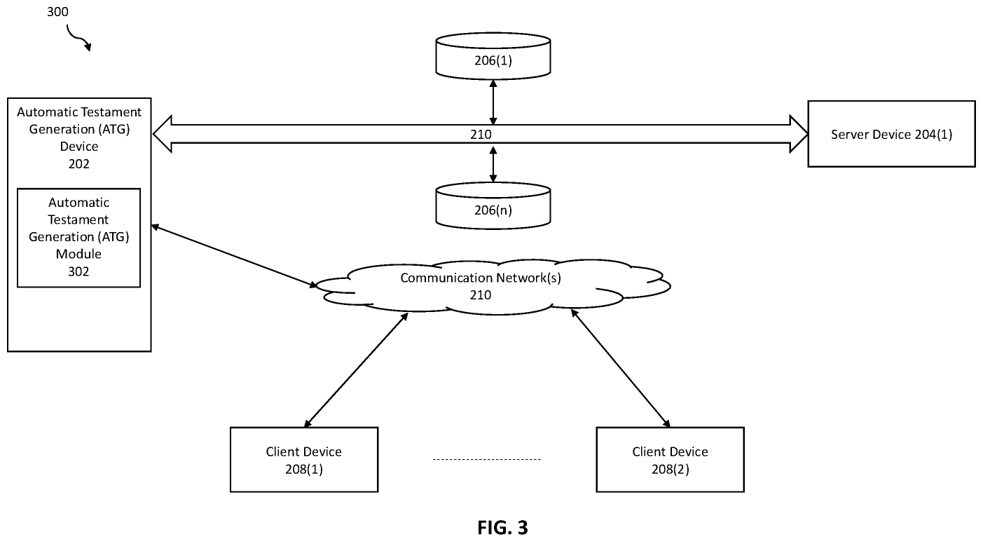

FIG. 3 illustrates an exemplary system for implementing a method for providing optimized asset allocation recommendations based on socio-economic trends in accordance with an exemplary embodiment. As illustrated in FIG. 3, according to exemplary embodiments, the system 300 may comprise an ATG device 202 including an Automatic Testament Generation (ATG) module 302 that may be connected to a server device 204(1) and one or more repository from the repositories 206(1) . . . 206(n) via a communication network 210, but the disclosure is not limited thereto.

The ATG device 202 is described and shown in FIG. 3 as including the ATG module 302, although it may include other rules, policies, modules, databases, or applications, for example. As will be described below, the ATG module 302 is configured to implement a method for providing optimized asset allocation recommendations based on socio-economic trends.

An exemplary process 300 for implementing a mechanism for providing optimized asset allocation recommendations based on socio-economic trends by utilizing the network environment of FIG. 2 is shown as being executed in FIG. 3. Specifically, a first client device 208(1) and a second client device 208(2) are illustrated as being in communication with ATG device 202. In this regard, the first client device 208(1) and the second client device 208(2) may be “clients” of the ATG device 202 and are described herein as such. Nevertheless, it is to be known and understood that the first client device 208(1) and/or the second client device 208(2) need not necessarily be “clients” of the ATG device 202, or any entity described in association therewith herein. Any additional or alternative relationship may exist between either or both of the first client device 208(1) and the second client device 208(2) and the ATG device 202, or no relationship may exist.

Further, the ATG device 202 is illustrated as being able to access one or more repositories 206(1) . . . 206(n). The ATG module 302 may be configured to access these repositories/databases for implementing a method for providing optimized asset allocation recommendations based on socio-economic trends.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the ATG device 202 via broadband or cellular communication. These embodiments are merely exemplary and are not limiting or exhaustive.

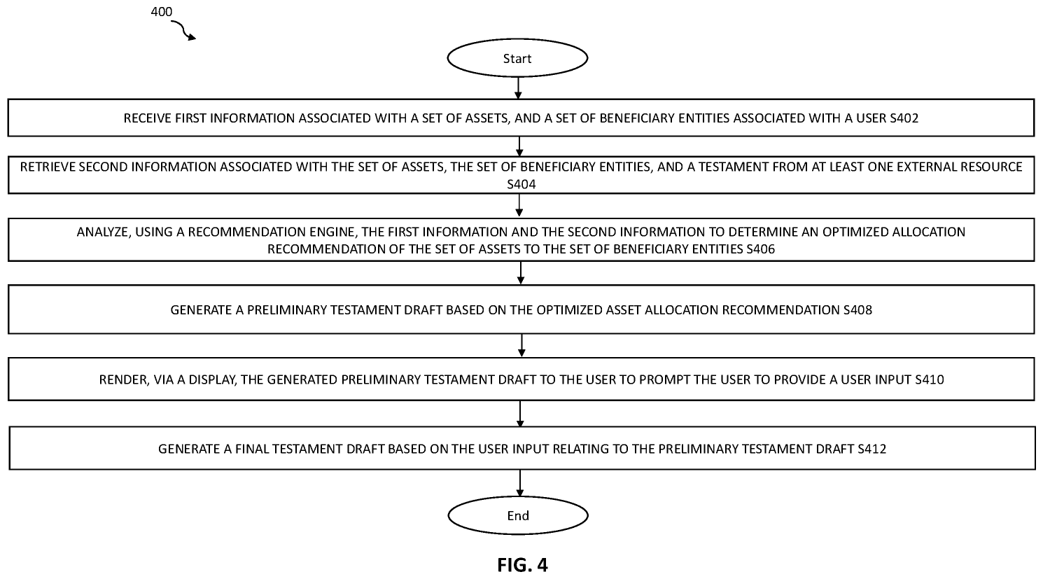

Referring to FIG. 4, an exemplary method 400 is shown for providing optimized asset allocation recommendations based on socio-economic trends in accordance with an exemplary embodiment. As shown in FIG. 4, the method begins following a need for optimized asset allocation recommendations based on socio-economic trends, further involving an optimized allocation of a set of assets to a set of beneficiary entities.

At step S402, the method includes receiving, by the at least one processor 104, first information associated with the set of assets, and the set of beneficiary entities associated with a user. In a non-limiting exemplary embodiment, the set of assets includes at least one from among a real estate asset, a hard commodities investment, a soft commodities investment, a stocks investment, a liquid asset, an intellectual property investment, and other investments and/or types of assets. The first information may include various attributes or details pertaining to an individual's (user's) assets. Such attributes may include but are not limited only to:
1) Type of asset (e.g., real estate, stocks, bonds, jewelry, vehicles, antiques, bank accounts, insurance policies, intellectual properties, and the like.).
2) The current valuation of each asset.
3) Location or jurisdiction of the asset (especially relevant for assets like real estate or foreign bank accounts).
4) Any existing liens, mortgages, or financial obligations related to the asset.
5) The historical performance of the asset (if relevant, such as stocks or mutual funds).

The set of assets can include a variety of investment types and categories that may include but are not limited only to:
1) Real Estate: This category includes multiple types of property such as Single Family Homes, Vacation Rentals, Office Buildings, Multi-Family Units, Industrial Lots, Raw Land, and Hotels. It also takes into consideration more specialized investment vehicles like Real Estate Investment Trusts (REITs) and Real Estate Investment Groups (REIGs).
2) Stock Market Investments: This encompasses a broad range of securities such as Mutual Funds, Exchange-Traded Funds (ETFs), Equity in the form of Employee Stock Ownership Plans (ESOPs)/Restricted Stock Units (RSUs), Fixed Income Investments, and Bonds.
3) Liquid Assets: These are more straightforward and include Cash Balances and Jewelry.
4) Intellectual Property Investments: This asset category includes elements like Logos, Trademarks, Patents, Copyrights, Customer Lists, Business Licenses, Franchises, Research Findings, and Secret Formulas.
5) Other Investments: This is a catch-all category that includes diverse assets like Crypto Investments, Vehicles, Equipment & Machinery, Digital Assets, and Valuable Paintings.
6) Hard Commodities Investments: Within this category, Base Metals like Aluminum, Copper, Lead, Mercury, Nickel, Tin, Zinc, and Titanium are considered. Precious Metals such as Gold, Silver, Platinum, and Palladium are also included. Additionally, Energy assets like Crude Oil, Petroleum, Gas Oil, Natural Gas, Heating Oil, Coal, and Electricity are taken into account.
7) Soft Commodities: This includes livestock and a range of agricultural products. Soft Agricultural Commodities include Cotton, Coffee, Cocoa, Orange Juice, Rubber, Sugar, Lumber, and Wool. Cereals cover Wheat, Corn, Soybeans, Rice, Oats, Rye, Barley, and Millet.

The processor 104 is configured to manage a complex array of assets, optimizing allocation based on variables that include not only the asset types but also considerations other factors that may include but are not limited to economic indicators, market trends, and individual preferences and needs of the dependent beneficiary entities. This results in a highly personalized and adaptive approach to asset management and testament generation.

Further, the processor 104 also receives data regarding the set of beneficiary entities associated with the user. The set of beneficiary entities includes individuals or organizations that might be beneficiaries of the set of assets associated with the user or have some stake in the user's assets. For example, upon the user's demise or as dictated by the user's financial planning, the set of assets may be allocated to the set of beneficiary entities. The set of beneficiary entities may further include individuals that are dependents on the user, for example, husband, wife, children, parents, grandparents, and the like. The first information associated with the set of beneficiary entities may be provided by the user. The first information associated with the set of beneficiary entities might include a variety of personal, financial, and lifestyle details. Specifically, the system may require the dependent's name, relationship with the user, and date of birth to establish identity and lineage. Moreover, the country and city of current residence are taken into account, potentially affecting tax implications and legal considerations.

The first information associated with the set of beneficiary entities may further include contact information such as phone numbers, as well as marital status, which may include additional factors such as any child support obligations if the dependent is divorced or whether the dependent is a single parent. The number of children and details about guardianship, particularly for minors, may also be included. Educational background, including qualifications and specializations, may be considered, particularly if there are educational trusts or funds to allocate. The first information associated with the set of beneficiary entities may further include employment status and approximate annual income that provide insights into the dependent's financial stability. This extends to the dependent's net asset value and any outstanding debts, which are essential for a comprehensive understanding of their financial situation. Details about home ownership, such as the current value of the home or future home-buying plans, are collected. This could affect decisions about the allocation of real estate assets or financial gifts.

Lastly, health and lifestyle factors are critical for long-term planning. The system may ask whether the dependent has any known or terminal illnesses or has any prolonged medical illness or medical conditions, for example, asthma, autism, autoimmune diseases, inflammation, kidney disease, lung diseases, obesity, Parkinson's disease, and the like as these could impact the urgency and nature of asset distribution. Lifestyle factors like smoking or drinking could be factored in for similar reasons, potentially affecting insurance premiums or medical expenses that need to be accounted for in the asset allocation.

The method employed to receive this first information can include direct user input through an interactive user interface (UI) module where the user fills out forms or answers questions. In another embodiment, the method for receiving the first information can include importing data from external financial management software or platforms the user might be using. In yet another embodiment, the method for receiving the first information can include scanning and processing physical or electronic documents provided by the user, such as bank statements, property deeds, or previous wills.

Upon receipt of the first information, the processor 104 may organize data associated with the first information. The organization of data may include parsing and classifying the data for easier processing in subsequent steps. Further, the processor 104 can categorize the set of assets based on their liquidity, value, or any other relevant parameter. Similarly, the set of beneficiary entities might be grouped based on their priority or the user's preferences. The organized data may then be stored in a secure manner, ensuring confidentiality and integrity.

In an example, a person is a 45-year-old entrepreneur, decides to use an automatic system to streamline the allocation of his diverse assets and draft a testament. When he accessed the web application, the system at step S402 prompted him for details regarding his assets. The person began by inputting real estate holdings: a house worth $1 million and a vacation home valued at $500,000. He then uploaded recent statements for his stock holdings, amounting to $300,000, and mutual funds, totaling $200,000. The application also inquired about personal items, to which the person added details of a vintage watch collection valued at $50,000 and two cars with a combined worth of $80,000.

Subsequently, the system requested information about the set of beneficiary entities he wished to benefit from his assets. The person listed his immediate family, comprising his wife, a homemaker; his son, a 20-year-old college student; and his daughter, who is 16 and in high school. Additionally, he entered details of a local charity he supports. As this information was provided, the system's processor 104 efficiently categorized and stored it. Real estate details were placed under ‘Property Holdings’, investments under ‘Financial Assets’, and personal items like watches and cars were categorized as ‘Personal Assets.’ His family members were grouped as ‘Immediate Family’, while the charity was stored under ‘Other Beneficiaries’. With this comprehensive data intake in step S402, the system was poised to analyze, optimize, and draft a testament that best aligned with the person's assets and his intentions for the set of beneficiary entities.

At step S404, the method includes retrieving, by the at least one processor 104, a second information associated with the set of assets, the set of beneficiary entities, and a testament from at least one external resource. The second information is distinct from the first information, which may include data directly related to the user's set of assets and beneficiary entities. The second information encompasses a broader range of economic, financial, and socio-political indicators. These indicators are essential for creating a more holistic, nuanced, and accurate asset allocation strategy adapted to the user's specific circumstances. The second information associated with the set of assets, the set of beneficiary entities, and a testament may include a multidimensional data set that incorporates various economic, social, and financial indicators, all aimed at providing a comprehensive overview. Specifically, this data set may include the Gross Domestic Product (GDP) of the country where the beneficiary entities reside (such as dependents of the user), along with projections of that country's future GDP outlook. Inflation and current unemployment rates for both the country and city of each beneficiary's residence are also accounted for, offering a more localized economic context.

To complement these macroeconomic indicators, financial metrics such as current interest rates on investments and debts, Consumer Confidence Index, Consumer Price Index, and Consumer Price Inflation Index are considered for the country and city of the beneficiaries' residences. This provides a nuanced understanding of consumer behavior and price stability, which could affect the value and utility of the set of assets.

The second information may further include financial market indicators specific to the user's portfolio. These may include credit ratings of stock market investments and price trends for any commodities held by the user. Moreover, stock market trends in the key markets of the beneficiary's country of residence are evaluated, looking at variables like average trading volumes, the valuation of securities, liquidity levels in the market, and dividend trends. These trends may signify a bullish or bearish market, affecting the strategy for asset allocation.

Furthermore, the processor 104 may consider real-time situational indicators such as current news related to social or political unrest, as well as health-related factors like the spread of illnesses or pandemics in the beneficiaries' (such as dependents of the user) country or city of residence. The factors are essential as they can drastically affect asset values and the well-being of the set of beneficiary entities (such as the dependents of the user).

It would be appreciated by the person skilled in the art that the second information includes not only the personal and financial details of the set of beneficiary entities but also the broader economic and social landscapes.

The processor 104 is configured to retrieve the second information from the at least one external resource. The at least one external resource may include databases, financial institutions, economic research organizations, government agencies, or news outlets. For example, real-time and historical data on GDP, inflation rates, and interest rates could be sourced from governmental economic databases. Stock market metrics such as credit ratings and trading volumes might be obtained from financial news websites or dedicated financial market platforms. Social and health-related factors, like news on political instability or ongoing health crises, might be sourced from reputable news outlets or health organizations.

The retrieval may be performed using secure data communication protocols to ensure the integrity and confidentiality of the retrieved second information. Once the processor 104 successfully acquires the second information, it integrates this data with the asset allocation and testament generation process. This enhances the ability of the method to generate a more optimized and context-aware preliminary and final testament draft. It would be appreciated by the person skilled in the art that the aim here is to create a more dynamic and responsive asset allocation and testament generation system. By considering both micro-level data like individual asset values and macro-level data like economic indicators, the system can adapt to a wide variety of conditions and offer asset allocation and testament suggestions that are both personalized and robustly informed.

In an example, a female user has various assets, including a house, some stocks, and a collection of valuable art. She also has two beneficiaries: her son and her daughter. After inputting all the relevant first information into the system-details about her assets and her beneficiaries the processor 104 fetches second information from the at least one external resource. It may pull the latest GDP figures and inflation rates from a government database to gauge the economic stability of the country where the user and her beneficiaries live. The processor 104 might also access a stock market platform to gather data about the credit ratings of the specific stocks the user owns and trends in trading volumes. Further, it may look into a news outlet's database for recent articles about political unrest or health crises that could affect the value or distribution of the user's assets. For example, if there is a downturn in GDP and a rising unemployment rate in the user's country, the system might recommend more conservative asset allocations. If the stocks the user owns have strong credit ratings and the stock market is trending upward, it might suggest allocating a higher percentage of her stocks to her beneficiaries. If there is political turmoil in the country, the system might advise her to diversify her investments or allocate more to liquid assets. The processor 104 then takes all this second information and incorporates it into the analysis, working in conjunction with the first information that was input initially. This helps in generating an optimized preliminary testament draft that considers not just the user's personal circumstances but also the broader economic and social context in which she and her beneficiaries exist. Thus, step S404 enriches the asset allocation and testament generation process by pulling in a wide array of contextual data, making the resulting recommendations much more informed and adaptive to current conditions.

At step S406, the method includes analyzing, by the at least one processor 104 using a recommendation engine, the first information and the second information to determine an optimized allocation recommendation of the set of assets to the set of beneficiary entities.

The first information generally relates to the set of assets owned by the user and the set of beneficiary entities for whom the set of assets needs to be allocated. This could include details like the types of the set of assets (e.g., real estate, stocks, bonds), their current value, and the specific needs or relationships of the set of beneficiary entities (e.g., spouse, children, other family members). The second information, obtained in step S404, comprises data and indicators from the at least one external resource. The second information can include economic metrics such as the GDP, inflation rate, interest rates, and other variables like stock market trends, social and political stability indicators, and localized data pertaining to the residence of the set of beneficiary entities.

The recommendation engine may correspond to a trained model employed by the processor 104 in step S406 that analyze the first information and the second information in tandem. It would be appreciated by the person skilled in the art that the goal herein is to derive an asset allocation that not only meets the user's wishes and the dependent's needs but is also resilient to economic fluctuations and other external factors. For example, suppose the user has two main types of assets: real estate and a stock portfolio. Their beneficiaries include a spouse and two children. The recommendation engine would consider the current market value of the real estate properties and stocks, the economic indicators in the area where the real estate is located, and the performance of the stock market sector in which the stocks are held. It might also consider the age of the children and perhaps even educational expenses if such data was part of the first information set.

Furthermore, the recommendation engine may use machine learning techniques to predict future asset growth or depreciation based on historical and real-time data, thereby aiding in long-term planning. The analysis might reveal, for example, that allocating a higher percentage of liquid assets like stocks to younger beneficiaries may be beneficial due to the long-term growth potential, whereas allocating stable but less liquid assets like real estate to a spouse may offer immediate financial security. After the analysis, an optimized allocation plan is derived, which is then used to generate a preliminary testament draft in the subsequent steps.

The recommendation engine may incorporate both the first information related to the user's set of assets and beneficiary entities, and the second information comprising external economic and social indicators to create a comprehensive dataset for analysis. The recommendation engine analyzes various economic indicators like GDP, inflation rate, interest rates, and the like, along with personal asset details. The recommendation engine may also consider specialized variables like the age of the set of beneficiary entities or specific needs stated by the user. Using machine learning, the recommendation engine is capable of projecting future asset values, allowing for long-term planning. Thus, the recommendation engine can adapt recommendations based on historical data and predictive analytics, considering factors like market trends and economic forecasts. The recommendation engine can employ optimization algorithms to allocate the set of assets in a way that meets the user's wishes while also considering the long-term economic security of the set of beneficiary entities. For example, it might allocate riskier but potentially higher-reward assets to younger beneficiaries of the set of beneficiary entities and more stable assets to older beneficiaries of the set of beneficiary entities or a spouse. The trained model can update itself based on the user input received on the preliminary testament draft. This ensures that the trained model becomes more accurate over time and can better adapt its recommendations to the user's needs. The trained model may be trained based on legal frameworks relevant to estate planning, ensuring that the asset allocation is not just optimized but also legally compliant. In an advanced setup, the recommendation engine could also periodically review and recommend adjustments to the asset allocation based on new data, keeping the testament up-to-date with the latest economic and personal situations.

In an embodiment, the processor 104 updates the recommendation engine based on the user input received.

First, this feature ensures that the recommendation engine becomes increasingly accurate and adapted to the user's specific needs and preferences over time. For instance, if a user consistently overrides the recommendation engine's asset allocation suggestions in favor of a higher allocation to a certain type of asset, such as real estate, the trained model will learn from this behavior. Subsequent recommendations will then be more aligned with the user's actual preferences, leading to an increasingly personalized experience.

Second, this feature allows the trained model to adapt to changes in user behavior or circumstances that may not be immediately captured by economic indicators or market data. For example, if the user recently had a child and updates their asset allocation to include a trust fund, the model will learn from this new information. Going forward, it may then factor in child-related considerations when generating asset allocation and testament suggestions.

Third, the updating of the recommendation engine adds a layer of adaptability to the system. This is critical in the ever-changing landscapes of financial markets and personal finance. By continually learning from the user, the trained model ensures that its recommendations remain relevant and timely, thereby enhancing the utility and effectiveness of the overall system. It would be appreciated by the person skilled in the art that the ability to update the recommendation engine based on user input not only improves the accuracy of asset allocation and testament generation but also enhances the system's adaptability and personalization capabilities. This feature positions the system as a dynamic, long-term solution for asset management and estate planning, capable of evolving with both market conditions and individual user needs.

At step S408, the method includes generating, by the at least one processor 104, the preliminary testament draft based on the optimized asset allocation recommendation. At step S408, the raw data, and optimized asset allocation strategies are transformed into a tangible output: the preliminary testament draft that may serve as a provisional blueprint for the distribution of the user's assets to the beneficiaries based on the complex analyses previously undertaken by the recommendation engine within the processor 104. Upon completion of the optimization analysis, the processor 104 utilizes a module for testament drafting. This module may employ predefined templates compliant with existing legal frameworks relevant to estate planning. However, it is not just a matter of filling in the blanks. The testament draft incorporates the optimized asset allocation plans, ensuring each asset, whether it be real estate, liquid assets, or other investments, is allocated to the appropriate set of beneficiary entities in the most effective manner as per the model's recommendations.

For example, a user has three main types of assets: real estate holdings, a stock portfolio, and liquid assets. The recommendation engine has recommended that real estate holdings should go to a beneficiary who is less financially stable and could benefit from long-term property investment. The stock portfolio might be divided among younger beneficiaries of the set of beneficiary entities who have a longer investment horizon, while liquid assets might be allocated to elderly beneficiaries of the set of beneficiary entities who may have immediate needs. All these optimized allocation decisions will be intricately detailed in this preliminary testament draft.

The preliminary testament draft is also structured to include optional clauses or conditional statements that could be triggered under specific scenarios. For instance, in the case of minor beneficiaries of the set of beneficiary entities, trust arrangements could be incorporated. These options are generated based on both the input data about the user's personal wishes and legal constraints, and the complex analytics performed by the recommendation engine. The preliminary testament draft serves a dual purpose. Firstly, it gives the user a tangible product to review, ensuring that their wishes are adequately represented and that they agree with the recommendations made by the system. Secondly, it sets the stage for further refinement either by the user or a pre-authorized legal entity, as specified in subsequent steps of the method. By synthesizing optimized asset allocation strategies into a coherent, legally-compliant preliminary testament draft, step S408 adds a critical layer of functionality to the invention, bridging the gap between abstract data analysis and real-world application.

The pre-authorized legal entity may include a law firm that specializes in estate planning and wills. These firms have legal practitioners who are trained in the nuances of testamentary law and can provide expert guidance on creating legally binding wills and testaments. Their expertise ensures that the created document adheres to the current legal standards and is not easily contestable in court.

The pre-authorized legal entity may further include a trust company. Trust companies are often authorized to act as trustees, executors, or administrators for individuals during the estate planning process. They manage, supervise, and transfer the set of assets as per the instructions in the will, testament, or trust. Their authorization ensures that the set of assets is handled professionally, mitigating potential conflicts among the set of beneficiary entities and ensuring a smooth transition of the set of assets.

Furthermore, the government or state-appointed legal bodies might also serve as pre-authorized legal entities. In many jurisdictions, certain governmental agencies oversee the registration and execution of wills and testaments. These agencies can provide authorization stamps or certifications, making a testament legally valid within that jurisdiction.

At step S410, the method includes rendering, by the at least one processor 104 via a display unit, the generated preliminary testament draft to the user to prompt the user to provide a user input. At step S410, a key user interface component of the invention comes into play, ensuring that the user can engage with and scrutinize the generated preliminary testament draft. Here, the processor 104 renders the preliminary testament draft via a display unit, which could be a part of a desktop computer, a laptop, a tablet, or even a smartphone.

Once the preliminary testament draft has been generated at step S408, the processor 104 interacts with the UI module. The UI module is specifically designed to convert the document format of the preliminary testament draft into a visually accessible and easily navigable layout. Various features like zoom-in/zoom-out, scroll, and section highlights might be provided to improve the user's engagement with the document. Additionally, tooltips or guidance notes could be embedded to explain technical jargon or specific allocations, further enhancing user comprehension.

The preliminary testament draft outlines the recommended allocation of the set of assets and is then displayed to the user via the UI module. Within the UI module, the user is provided with options to view the set of assets allocation either by asset type or by the set of beneficiary entities, allowing for a customized perspective adapted to the user's specific interests or concerns. Significantly, the system also offers the user the flexibility to modify the initial recommendations made by the recommendation engine. The user can override the suggested values for asset allocation, and a provision is available for the user to add comments explaining the reason for such overrides. These comments are particularly important, as they feed into the machine learning aspect of the recommendation engine. The system “learns” from these comments, adapting the machine learning aspect of the recommendation engine to provide more nuanced and intelligent recommendations in future iterations of asset allocation and testament drafting.

It would be appreciated by the person skilled in the art that the preliminary testament draft serves not just as a static document but as an interactive tool that engages the user in a feedback loop. This creates a more dynamic, adaptable, and intelligent system for asset allocation and estate planning, capable of evolving based on user input and experience.

For example, if the preliminary testament draft has allocated real estate properties to Beneficiary A, stocks to Beneficiary B, and liquid assets to Beneficiary C, each section of the draft displayed on the screen may include an interactive icon. When the user hovers over or clicks on these icons, a tooltip might appear, providing more context or rationale behind each asset allocation as determined by the optimized model in the previous steps. Furthermore, the UI module could also incorporate interactive features that allow the user to make quick edits or to flag sections for later review. These interactive capabilities serve as the foundation for potential refinement of the preliminary testament draft, as the user could immediately respond with their input or questions. Importantly, step S410 is not just a one-way presentation of information. By rendering the preliminary testament draft in an interactive manner, enables the user to fine-tune the document based on user or legal feedback.

At step S412, the method includes generating, by the at least one processor 104, a final testament draft based on the received user input relating to the preliminary testament draft. The step S412 acts as a culminating point where various earlier steps of the method, including the received user inputs, optimized asset allocations, and potentially user-altered preliminary testament draft, are amalgamated into a finalized document suitable for legal procedures. The processor 104 may employ a complex algorithmic approach, such as natural language processing and legal compliance checks, to ensure that the final testament draft meets both the user's intent and the applicable legal standards.

Upon receiving any user modifications or confirmations related to the preliminary testament draft, as was rendered in step S410, the processor 104 begins the process of generating the final testament draft. This could involve the use of additional sub-modules designed to validate the legal language, cross-verify the user's asset allocations, and ensure that all necessary clauses are intact. For example, a “Legal Compliance Checker” submodule might scan through the draft to verify that the language used complies with the specific testamentary laws applicable to the user's jurisdiction. Additionally, the processor 104 might also integrate any last-minute asset information updates or changes in the statuses of the set of beneficiary entities. For instance, if between the time of preliminary and final testament draft generation, a new asset has been added to the portfolio or a dependent's residency status has changed, the processor 104 would account for these updates.

In an embodiment, the recommendation engine that corresponds to a machine learning model may be configured such that to learn from user alterations to the preliminary testament draft, making the system progressively smarter in understanding the user's preferences and legal necessities. Once the final testament draft is generated, it may be stored in a secure digital vault (such as a database) within the system, awaiting the next steps, which may involve legal reviews, digital or physical signatures, and notarization. This secure storage ensures that the final testament draft is both tamper-evident and retrievable for future amendments or legal procedures.

In an embodiment, after the preliminary testament draft is rendered to the user as described in step S410, the method further incorporates an additional layer of customization and validation. The processor 104 is configured to receive user input based on the displayed preliminary testament draft. This allows the user to make adjustments, corrections, or additions to the preliminary testament draft, thus personalizing it to better suit their specific requirements or circumstances. The user may make these changes through the UI module, perhaps via textual inputs, drop-down selections, or even voice commands which are then processed and interpreted by the system.

Additionally, the method has provisions for enhancing the legal robustness of the testament by involving a pre-authorized legal entity. After the preliminary testament draft is rendered, the processor 104 is configured to receive input from this legal entity, which could be a law firm, a legal advisor, or an automated legal compliance service. The pre-authorized legal entity reviews the preliminary testament draft to ensure its compliance with local, state, or national laws and may suggest amendments or improvements to fortify its legal standing.

Both the user input and the input from the pre-authorized legal entity are factored into the generation of the final testament draft in step S412. The processor 104 amalgamates these inputs with the existing data, running them through the internal algorithms and, if applicable, machine learning models for asset allocation and legal phrasing. This way, the final testament draft is a composite document that not only reflects the user's original intent and optimized asset distribution but is also vetted for legal accuracy and individual customization.

Therefore, by receiving and incorporating these two additional sets of inputs, the system ensures that the final testament draft is both a personalized representation of the user's wishes and is legally compliant. This multi-layered validation and customization process significantly elevates the reliability and applicability of the automated testament generation system, making it a comprehensive solution for modern estate planning.

In an embodiment, after the final testament draft is generated by integrating the user's input and the feedback from the pre-authorized legal entity as described in step S412, the processor 104 carries out an important function: it displays the generated final testament draft via a display unit.

In an exemplary embodiment, the UI module of the display unit, multiple versions of testaments are presented for user selection. These versions are generated based on the optimized asset allocation across the diverse range of the set of assets and the set of beneficiary entities. Each version may have unique nuances, accommodating different asset-to-beneficiary distributions, tax implications, or legal requirements, thus giving the user a range of options that best fit their specific estate planning needs. The user is then provided with the option to select one of these versions for further review or finalization. This feature is particularly beneficial as it allows the user to consider various scenarios and implications before settling on a final document, thus empowering the user to make more informed decisions about their estate.

In another embodiment, the multiple versions of testaments are based on acceptance (i.e., approval) or rejection inputs provided by the user. After the preliminary testament draft is displayed, the user can review and either accept or reject allocations of the set of assets and other conditions outlined in the document. Their input is then used to generate alternative versions of the testament that reflect different asset-to-beneficiary distributions, legal stipulations, or any other user-specified parameters. This allows for a more personalized estate planning process, as the system dynamically adapts to the user's preferences and requirements. Subsequent versions aim to align more closely with the user's wishes, thereby making the final testament more adapted to individual needs. This interactive and responsive feature enriches the user experience and ensures that the final testament is a true reflection of the user's estate planning objectives.

In an example, a user initiates the system to create a testament. He has various types of assets like real estate, stock market investments, and liquid assets. The system presents an initial draft of the testament that recommends allocating his primary residence to his daughter, his stock market investments to his son, and his liquid assets to be divided among his spouse and two children. Upon reviewing the preliminary testament draft, the user may feel that the allocation does not fully align with his wishes. He rejects the initial recommendation and inputs his reason: “I want daughter to also have a portion of the stock market investments since she has an interest and knowledge in finance.” Taking this rejection and the associated comment into account, the system generates a second version of the testament. This time, it recommends splitting the stock market investments between daughter and son while keeping the other asset allocations as they were. User reviews the second draft and finds it aligns well with his wishes. He accepts this version, which then becomes his final testament draft. This interactive process allows the testament to be finely tuned according to his preferences, showcasing how the system adapts to user input to generate a more personalized and suitable testament.

Firstly, the user is provided with an immediate and transparent overview of the finalized testament, enabling them to visually confirm that their wishes and legal requirements have been accurately captured. This display could be rendered on various types of screens, such as a computer monitor, tablet, or even a smartphone, depending on the system's design and user accessibility preferences.

Secondly, a visual representation of the final testament draft serves as a point for any last-minute revisions or approvals. If the user identifies any aspect that requires modification, they can choose to loop back to earlier steps for further customization, potentially re-engaging with the UI module for changes or seeking additional feedback from the pre-authorized legal entity.

Lastly, the display of the final testament draft paves the way for its formalization, which could involve digital signing, notarization, or any other legal formalities required to convert the draft into a legally binding document. The display unit may also present options to export the document in various formats like PDF, or to send it directly to relevant parties via email or other secure channels.

Therefore, the step of displaying the generated final testament draft serves not just as a culmination of the automated process, but also as a gateway to the final, critical tasks of review and formalization. This ensures that the testament is not only optimized and personalized but is also prepared for immediate legal implementation, thereby completing the full cycle of the optimized asset allocation recommendations based on the socio-economic trends system.

In an embodiment, the method includes a set of provisions for ongoing updates and refinements. These features are designed to ensure that the generated testament and asset allocation stay relevant and optimized even in the face of fluctuating economic conditions, updated market data, and evolving legal frameworks.

Firstly, the at least one processor 104 is configured to periodically review changes in various economic indicators, historical market data, and existing legal frameworks relevant to estate planning. This review occurs at predefined time intervals, which can be set according to the user's preference or based on best practices within the field of estate planning. This ensures that the generated final testament draft and allocation of the set of assets are always aligned with the most current data and legal requirements.

Secondly, based on the review, the processor 104 is configured to generate a set of modifications in the optimized asset allocation. These modifications are calculated to reflect any changes in the reviewed parameters, thus ensuring that the testament remains viable, legal, and optimized. For example, if the inflation rate has risen substantially since the last review, the asset allocation may be adjusted to allocate more assets of the set of assets into investment options that historically outpace inflation.

Thirdly, once the modifications are generated, they are not implemented blindly; instead, the processor 104 recommends these changes to the user via the display unit. This step ensures that the user retains ultimate control over their estate and testament plans. The user can review these suggestions and decide whether to accept, reject, or modify them.

Lastly, the processor 104 also generates an alert based on the set of modifications. This alert acts as a proactive notification to the user, indicating that there are recommended changes awaiting their review. This alert can be customized to be delivered via various channels, such as email, short messaging service (SMS), i.e., text message, or even as a push notification from an application, depending on the system's capabilities and the user's preferences. It would be appreciated by the person skilled in the art that the feature of ongoing review and update offers a dynamic, responsive system that adapts to changing conditions while also respecting the user's autonomy and need for control over their own testament and asset allocation. This adds an additional layer of sophistication and personalization, making the system not just a one-time solution, but a long-term estate planning tool.

In an embodiment, the UI module may be configured to offer enhanced flexibility and adaptability. One such feature is a dedicated button labeled, for example, “Regenerate Testament Based on Updated Socio-Economic Data.” Upon clicking this button, the processor 104 instantly pulls the latest socio-economic data, such as GDP trends, inflation rates, or stock market conditions, to recalculate asset allocations and generate a new testament draft.

This feature is particularly useful in dynamic financial landscapes, allowing the testament to stay relevant and optimized according to the latest economic conditions. It provides the user with an option to align the asset allocation and testament provisions with current socio-economic realities, thus ensuring the testament remains effective and reflective of the most recent circumstances.

Additionally, the UI module also incorporates an option labeled “Update Dependent Information.” This allows the user to make changes to the first set of information related to the dependents-such as changing a dependent's employment status or adding a newly born child to the list of the set of beneficiary entities. After updating this information, the user can choose to regenerate the testament, which will then consider these updated details in the newly generated draft.

Both these options add layers of customization and adaptability to the system, making it easier for users to keep their testament up-to-date and aligned with their current wishes and the latest socio-economic indicators.

In an example, a user initially filled in information about his two children, his wife, and his sister as the beneficiaries. He also input details about his various assets, including real estate, stock investments, and some patents he owns. The user first generated a testament six months ago. Since then, he has welcomed a new baby into the family. The stock market has also experienced significant volatility, and new tax laws have been implemented.

The user logs into the system and notices the stock market is in a downturn, which could impact his estate's value. He clicks on the “Regenerate Testament Based on Updated Socio-Economic Data” button. The system automatically fetches the latest socio-economic data, recalculates the optimized asset allocation, and presents the user with a new testament draft that adjusts for the current stock market conditions.

The user also wants to add his new baby as a beneficiary. He clicks on the “Update Dependent Information” button, adds the details of his new child—such as name, relationship, date of birth, etc.—and saves the changes. The system now considers this new beneficiary in the asset allocation. After both updates, the user clicks a button to see the revised testament. It now includes provisions for his new child and adjusts the asset allocations to better suit the current economic trends. The user reviews the changes and is satisfied that his testament is both current and optimized, so he finalizes the new draft of the testament.

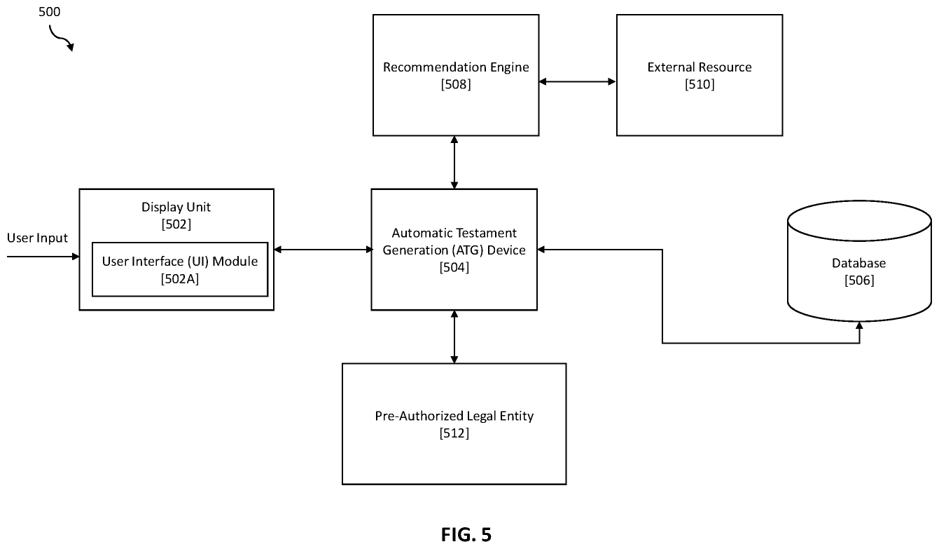

FIG. 5 illustrates a process flow diagram usable for optimized asset allocation recommendations based on socio-economic trends, in accordance with an exemplary embodiment. As illustrated in FIG. 5, the process flow 500 begins with receiving a first information associated with a set of assets, and a set of beneficiary entities associated with a user via a user interface (UI) module 502A of a display unit 502. The Automatic Testament Generation (ATG) device 504 receives, via the UI module 502A, essential information about the user's set of assets, which can include, but are not limited to, real estate, commodities, stocks, and liquid assets. The first information also includes a list of the set of beneficiary entities related to the user, like family members or organizations that may inherit these assets. This data reception can also happen through a secure web interface or application where the user inputs relevant details.

Thereafter, a recommendation engine 508 may fetch additional data from external resource 510, including government databases or trusted news outlets, to gauge the economic stability and market conditions. It gathers real-time economic indicators like GDP, inflation rates, unemployment rates, and others to form a complete picture of the economic landscape. Further, the recommendation engine 508 uses machine learning techniques, to perform a multi-variable analysis on both the first information and the second information. The goal is to determine an optimized asset allocation plan that balances the user's financial benefits and the needs of the set of beneficiary entities.

Based on the optimized asset allocation plan, a preliminary testament draft is automatically generated by the processor 104 that outlines how assets would be distributed among the set of beneficiary entities and under what conditions. The preliminary testament draft is stored on a database 506 and is displayed via the UI module 502A of the display unit 502. The user can review the preliminary testament draft and provide feedback. The ATG device 504 is also capable of receiving input from a pre-authorized legal entity 512 to make sure the testament is up to legal standards. Taking into account the user and legal inputs, the ATG device 504 refines the draft to produce a final version. This final testament draft is again stored on the database 506 and is displayed via the UI module 502A of the display unit 502 to receive the user input for approval or any further revisions. The ATG device 504 does not treat the final testament draft as the end. It keeps monitoring in real-time the relevant economic and legal data to suggest timely modifications in the asset allocation. These updates are relayed to the user as recommendations, and alerts can be generated to prompt user action. Further, any user feedback received through the system is used to update the recommendation engine 508. This makes the system adaptive and improves its decision-making capabilities over time. The system is versatile enough to handle various types of assets, whether they be physical, like real estate, digital like intellectual property, or financial, like stock options. The ATG device 504 may extract data from external resource 510 via the recommendation engine 508, that include dataset associated with economic indicators, market trends, legal changes, and even geopolitical events that could affect asset values. It would be appreciated by the person skilled in the art that the ATG device 504 offers a full-circle, adaptable, and intelligent solution for automating the highly complex task of asset allocation and testament drafting.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for optimized asset allocation recommendations based on socio-economic trends is disclosed. The instructions include executable code which, when executed by a processor, may cause the processor to receive first information associated with a set of assets, and a set of beneficiary entities associated with a user; retrieve second information associated with the set of assets and a testament from at least one external resource; analyze, using a recommendation engine, the first information and the second information to determine an optimized allocation recommendation of the set of assets to the set of beneficiary entities; generate a preliminary testament draft based on the optimized asset allocation recommendation; render, via a display unit, the generated preliminary testament draft to the user to prompt the user to provide a user input; and generate a final testament draft based on the user input relating to the preliminary testament draft.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing an optimized asset allocation recommendation, the method being implemented by at least one processor, the method comprising:
receiving, by the at least one processor, first information associated with a set of assets, and a set of beneficiary entities associated with a user;
retrieving, by the at least one processor, second information associated with the set of assets, the set of beneficiary entities, and a testament from at least one external resource;
analyzing, by the at least one processor using a recommendation engine, the first information and the second information to determine an optimized allocation recommendation of the set of assets to the set of beneficiary entities;
generating, by the at least one processor, a preliminary testament draft based on the optimized asset allocation recommendation;
rendering, by the at least one processor via a display, the generated preliminary testament draft to the user to prompt the user to provide a user input; and
generating, by the at least one processor, a final testament draft based on the user input.

2. The method as claimed in claim 1, wherein the generating of the final testament draft comprises:
modifying, by the at least one processor, the preliminary testament draft based on the user input; and
receiving, by the at least one processor from a pre-authorized legal entity, an input that relates to the modified preliminary testament draft,
wherein the generating of the final testament draft is further based on the received input from the pre-authorized legal entity.

3. The method as claimed in claim 1, wherein the generating of the final testament draft comprises:
analyzing, by the at least one processor, the user input to determine that the user has approved the preliminary testament draft; and
receiving, from a pre-authorized legal entity, an input that relates to the approved preliminary testament draft,
wherein the generating of the final testament draft is further based on the received input from the pre-authorized legal entity.

4. The method as claimed in claim 1, wherein the method further comprises displaying, by the at least one processor via the display, the generated final testament draft.

5. The method as claimed in claim 1, wherein the second information comprises a real-time economic indicator, a historical market data, and an existing legal framework that is relevant to estate planning.

6. The method as claimed in claim 5, wherein the method further comprises:
periodically reviewing, by the at least one processor, a change in at least one from among the economic indicator, the historical market data, and the existing legal framework that is relevant to estate planning after a predefined time period;
generating, by the at least one processor, a set of modifications in the optimized asset allocation recommendation based on the change in the at least one from among the economic indicator, the historical market data, and the existing legal framework that is relevant to estate planning;
recommending, by the at least one processor, the generated set of modifications to the user; and
generating, by the at least one processor, an alert to the user based on the recommendation of the generated set of modifications.

7. The method as claimed in claim 1, wherein the method further comprises updating, by the at least one processor, the recommendation engine based on the user input.

8. The method as claimed in claim 1, wherein the set of assets comprises at least one from among a real estate asset, a hard commodities investment, a soft commodities investment, a stocks investment, a liquid asset, and an intellectual property investment.

9. The method as claimed in claim 1, wherein the at least one external resource corresponds to at least one from among economic and market indicators, news and current affairs, and socio-economic and geo-political realities that affect a valuation of the set of assets.

10. A computing device configured to implement an execution of a method for providing an optimized asset allocation recommendation, the computing device comprising:
a processor,
a memory; and
a communication interface coupled to each of the processor and the memory, wherein the processor is configured to:
receive first information associated with a set of assets, and a set of beneficiary entities associated with a user;
retrieve second information associated with the set of assets, the set of beneficiary entities and a testament from at least one external resource;
analyze, using a recommendation engine, the first information and the second information to determine an optimized allocation recommendation of the set of assets to the set of beneficiary entities;
generate a preliminary testament draft based on the optimized asset allocation recommendation;
render, via a display, the generated preliminary testament draft to the user to prompt the user to provide a user input; and
generate a final testament draft based on the user input.

11. The computing device as claimed in claim 10, wherein to generate the final testament draft, the processor is further configured to:
modify the preliminary testament draft based on the user input; and
receive, from a pre-authorized legal entity, an input that relates to the modified preliminary testament draft,
wherein the generation of the final testament draft is further based on the received input from the pre-authorized legal entity.

12. The computing device as claimed in claim 10, wherein to generate the final testament draft, the processor is further configured to:
analyze the user input to determine that the user has approved the preliminary testament draft; and
receive, from a pre-authorized legal entity, an input that relates to the approved preliminary testament draft,
wherein the generation of the final testament draft is further based on the received input from the pre-authorized legal entity.

13. The computing device as claimed in claim 10, wherein the processor is further configured to display, via the display, the generated final testament draft.

14. The computing device as claimed in claim 10, wherein the second information comprises a real-time economic indicator, a historical market data, and an existing legal framework that is relevant to estate planning.

15. The computing device as claimed in claim 14, wherein the processor is further configured to:
periodically review a change in at least one from among the economic indicator, the historical market data, and the existing legal framework that is relevant to estate planning after a predefined time period;
generate a set of modifications in the optimized asset allocation recommendation based on the change in the at least one from among the economic indicator, the historical market data, and the existing legal framework that is relevant to estate planning;
recommend the generated set of modifications to the user; and
generate an alert to the user based on the recommendation of the generated set of modifications.

16. The computing device as claimed in claim 10, wherein the processor is further configured to update the recommendation engine based on the user input.

17. The computing device as claimed in claim 10, wherein the set of assets comprises at least one from among a real estate asset, a hard commodities investment, a soft commodities investment, a stocks investment, a liquid asset, and an intellectual property investment.

18. The computing device as claimed in claim 10, wherein the at least one external resource corresponds to at least one from among economic and market indicators, news and current affairs, and socio-economic and geo-political realities that affect a valuation of the set of assets.

19. A non-transitory computer readable storage medium storing instructions for providing an optimized asset allocation recommendation, the instructions comprising executable code which, when executed by a processor, causes the processor to:
receive first information associated with a set of assets, and a set of beneficiary entities associated with a user;
retrieve second information associated with the set of assets, the set of beneficiary entities and a testament from at least one external resource;
analyze, using a recommendation engine, the first information and the second information to determine an optimized allocation recommendation of the set of assets to the set of beneficiary entities;
generate a preliminary testament draft based on the optimized asset allocation recommendation;
render, via a display, the generated preliminary testament draft to the user to prompt the user to provide a user input; and
generate a final testament draft based on the user input.

20. The storage medium as claimed in claim 19, wherein to generate the final testament draft, when executed by the processor, the executable code further causes the processor to:
modify the preliminary testament draft based on the user input; and
receive, from a pre-authorized legal entity, an input that relates to the modified preliminary testament draft,
wherein the generation of the final testament draft is further based on the received input from the pre-authorized legal entity.
